(19) United States
(12) Patent Application Publication
(10) Pub. No.: US 2025/0299123 A1
(43) Pub. Date: Sep. 25, 2025

(54) DYNAMIC STATE MACHINE FOR RESCUE OPERATIONS

(71) Applicant: Allstate Insurance Company, Northbrook, IL (US)

(72) Inventors: David H. Colvin, Jacksonville, FL (US); Benjamin Zethmayr, Justice, IL (US); Scott J. Gaboury, Charlotte, NC (US); Monkar Nath Pathak, Northbrook, IL (US)

(21) Appl. No.: 18/022,240

(22) PCT Filed: Feb. 17, 2023
(86) PCT No.: PCT/US2023/013293

§ 371 Date: Feb. 20, 2023

(30) Foreign Application Priority Data
Dec. 13, 2022 (IN) 202241071882

(51) Int. Cl. G06Q 10/0631

(52) U.S. Cl. CPC G06Q 10/063114

(57) ABSTRACT

Aspects of the present disclosure generally relate to systems and methods for implementing a state engine, and more specifically, to implementing a state engine for managing rescue operations. An example apparatus generally includes: an interface of a state engine receiving an input indicating a transition to a target state of the state engine, the target state being a state associated with a vehicle rescue operation; a verification component coupled to the interface, the verification component identifying whether the transition to the target state is valid based on one or more constraints associated with the state engine; and a transition component coupled to the verification component, the transition component performing the transition to the target state based on the identification of whether the transition to the target state is valid.

### CROSS-REFERENCE TO RELATED APPLICATIONS

The present application claims priority to Indian Application No. 202241071882 filed on Dec. 13, 2022, which is incorporated by reference in its entirety herein.

### TECHNICAL FIELD

Aspects of the present disclosure generally relate to systems and methods for implementing a state engine, and more specifically, to systems and methods for providing rescue operations using a state engine.

### BACKGROUND

Rescue operations, such as roadside assistance, may be provided in various circumstances for users, vehicles, and/or the like. Such rescue operations are often dynamic and involve information from disparate sources at a rapid pace. Reconciling and validating the information in connection with execution of a rescue operation is challenging, which exacerbates the difficulties of communicating with a user regarding the status of a rescue operation.

### SUMMARY

Implementations described and claimed herein address the forgoing by providing systems and methods for managing rescue operations using a state engine. Certain aspects of the present disclosure are directed towards an apparatus for vehicle rescue. The apparatus generally includes: an interface of a state engine receiving an input indicating a transition to a target state of the state engine, the target state being a state associated with a vehicle rescue operation; a verification component coupled to the interface, the verification component identifying whether the transition to the target state is valid based on one or more constraints associated with the state engine; and a transition component coupled to the verification component, the transition component performing the transition to the target state based on the identification of whether the transition to the target state is valid.

Certain aspects of the present disclosure are directed towards an apparatus for vehicle rescue. The apparatus generally includes: an interface of a state engine receiving an input indicating an occurrence of an event associated with a vehicle rescue operation; a verification component coupled to the interface, the verification component identifying whether a current state of the state engine allows for the event to occur based on one or more constraints associated with the state engine; and an action component coupled to the verification component, the action component performing one or more actions associated with the event based on the identification of whether the current state is allowed.

Certain aspects of the present disclosure are directed towards a non-transitory computer-readable medium having instructions stored thereon, which when executed by an apparatus, cause the apparatus to: receive, via an interface of a state engine, an input indicating a transition to a target state of the state engine, the target state being a state associated with a vehicle rescue operation; identify, via a verification component coupled to the interface, whether the transition to the target state is valid based on one or more constraints associated with the state engine; and perform, via a transition component coupled to the verification component, the transition to the target state based on the identification of whether the transition to the target state is valid.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example operating environment for providing vehicle rescue.

FIG. 2 illustrates an example computing device including a state engine.

FIG. 3 is a flow diagram of an example state machine for implementing a vehicle rescue operation.

FIG. 4 is a block diagram illustrating example operations for transitioning from one state to another state of a state diagram.

FIG. 5 is a block diagram illustrating example operations for implementing an action.

FIG. 6 is a block diagram illustrating example operations for processing an event.

FIG. 7 is a block diagram illustrating example operations for performing one or more actions in connection with a rescue.

FIG. 8 is a flow diagram illustrating example operations for providing rescue status updates.

FIG. 9 is a flow diagram illustrating example operations for providing rescue status updates.

It will be apparent to one skilled in the art after review of the entirety disclosed that the steps illustrated in the figures listed above may be performed in other than the recited order, and that one or more steps illustrated in these figures may be optional.

### DETAILED DESCRIPTION

Certain aspects of the present disclosure are directed to methods and systems for providing rescue updates using a dynamic state engine (e.g., also referred to as a state machine). A state machine reads a set of inputs and changes to a different state based on those inputs. A state is a description of the status of a system waiting to execute a transition. A state machine may be implemented with an architecture that allows flow to states depending on values from previous states or inputs from other systems. The state engine may be used to send short message service (SMS) messages that provide updates to a user regarding a state of a rescue operation. For example, a vehicle may break down and request towing. In this case, the state engine may manage the towing operation, keeping track of the state of the rescue and providing SMS (or using any suitable messaging system) messages to the vehicle owner until the rescue operation has been completed. The state engine enables roadside service providers to provide customized communication to each user based on various rescue factors. The rescue factors may be used to determine a message to be sent to the user. Based on these factors, many permutations of customized language and timing are identified for the message to the user. The dynamic SMS state engine provided herein increases transparency and reduces user anxiety by providing real-time updates, including global positioning system (GPS) predicted arrival times. The state engine considers various processes, events, and states to manage the rescue communication lifecycle and send out messages to the user.

These and various other techniques will be described more fully herein. As will be appreciated by one of skill in the art upon reading the following disclosure, various aspects described herein can be a method, a computer system, or a computer program product. Accordingly, those aspects can take the form of an entirely hardware implementation, an entirely software implementation, or at least one implementation combining software and hardware aspects. Furthermore, such aspects can take the form of a computer program product stored by one or more computer-readable storage media having computer-readable program code, or instructions, included in or on the storage media. Any suitable computer-readable storage media can be utilized, including hard disks, CD-ROMs, optical storage devices, magnetic storage devices, and/or any combination thereof. In addition, various signals representing data or events as described herein can be transferred between a source and a destination in the form of electromagnetic waves traveling through signal-conducting media such as metal wires, optical fibers, and/or wireless transmission media (e.g., air and/or space).

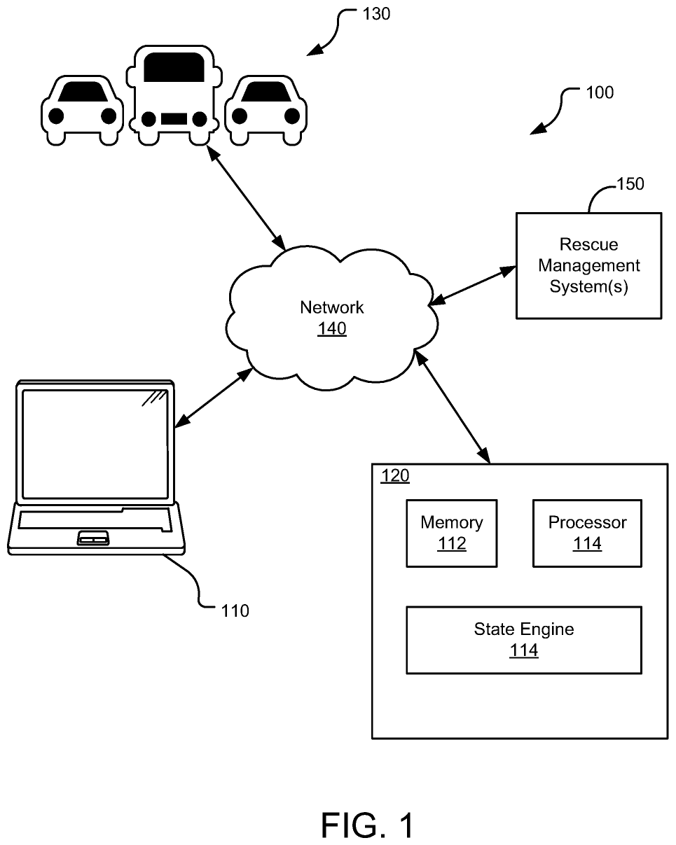

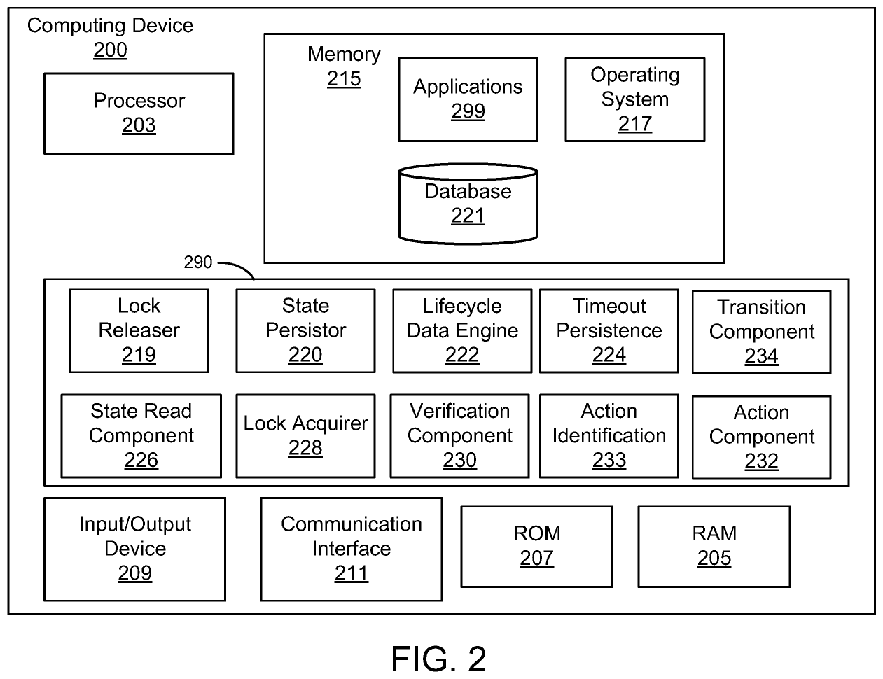

FIG. 1 illustrates an operating environment 100 in accordance with at least one implementation. The operating environment 100 includes at least one client device 110, and/or at least one of vehicles 130 in communication via a network 140. Client devices 110 and rescue system 120 can allow users to obtain rescue services for a vehicle, such as vehicles 130. Network 140 can include a local area network (LAN), a wide area network (WAN), a wireless telecommunications network, and/or any other communication network or combination thereof. Any of the devices and systems described herein can be implemented, in whole or in part, using one or more computing devices described with respect to FIG. 2. For example, rescue system 120 may include one or more processors 114 and a non-transitory memory 112. Client devices 110 and/or the at least one vehicle 130 may include similar components, in addition to other components described below. The vehicles 130 may include a user vehicle which may request rescue, or a provider vehicle seeking to provide a rescue service (e.g., towing) for the user. As shown, one or more management systems 150 may communicate with the rescue system 120 and provide inputs to the rescue system 120. For example, one of the management systems 150 may provide access to service providers or other managing individuals to indicate the occurrence of various events associated with the rescue. Such events may indicate, as one example, that a provider for rescue has been booked, resulting in a transition change of the state engine of the rescue system 120 and/or performance of one or more actions (e.g., sending of messages).

Vehicles 130 can be, for example, an automobile, motorcycle, scooter, bus, recreational vehicle, boat, or other vehicle for which sensor or crash data can be collected and analyzed. A telematics device within the vehicle 130 can be used to collect and/or receive sensor data and/or to receive sensor data from the vehicle 130. A telematics device can be, for example, mobile phones, tablet computers, laptop computers, wearables, user devices, smartwatches, and other devices that can be carried by drivers or passengers inside or outside of the vehicle 130. The telematics device can also be integrated into the vehicle 130 and/or connected to a data bus within the vehicle 130 via a diagnostic connector, such as an OBD-II connector. The telematics device can receive a variety of data, such as acceleration, velocity, location, vehicle operation data such as braking, turning, swerving, and the like from sensors located within the telematics device and/or vehicle. For example, a telematics device having a GPS receiver can determine vehicle location, speed, direction, and other basic driving data without needing to communicate with vehicle sensors or external vehicle systems. However, it should be noted that any of a variety of other location determination techniques, such as location determined based on wireless networks to which the mobile device is connected, such as Wi-Fi networks, cellular networks, and the like, can also be used.

Vehicle 130 can further include a short-range communication system. The short-range communication systems can be a vehicle-based data transmission systems configured to transmit vehicle operational data to other nearby vehicles, and to receive vehicle operational data from other nearby vehicles. In some examples, communication system can use the dedicated short-range communications (DSRC) protocols and standards to perform wireless communications between vehicles. In the United States, 75 MHz in the 5.850-5.925 GHz band have been allocated for DSRC systems and applications, and various other DSRC allocations have been defined in other countries and jurisdictions. However, short-range communication system need not use DSRC, and can be implemented using other short-range wireless protocols in other examples, such as WLAN communication protocols (e.g., IEEE 802.11), Bluetooth (e.g., IEEE 802.15.1), or one or more of the Communication Access for Land Mobiles (CALM) wireless communication protocols and air interfaces. Vehicle-to-vehicle (V2V) transmissions between the short-range communication system can be sent via DSRC, Bluetooth, satellite, GSM infrared, IEEE 802.11, WiMAX, RFID, and/or any suitable wireless communication media, standards, and protocols. In certain systems, the short-range communication system can include specialized hardware installed in vehicle 130 (e.g., transceivers, antennas, etc.), while in other examples the short-range communication system can be implemented using existing vehicle hardware components (e.g., radio and satellite equipment, navigation computers) or can be implemented by software running on a telematics device within (or near) the vehicle 130. The range of V2V communications can depend on the wireless communication standards and protocols used, the transmission/reception hardware (e.g., transceivers, power sources, antennas), and other factors. Short-range V2V communications can range from just a few feet to many miles, and different types of driving behaviors, vehicle operational parameters, and the like, can be determined depending on the range of the V2V communications.

The data transferred to and from various devices in operating environment 100 can include secure and sensitive data. Therefore, it can be desirable to protect transmissions of such data using secure network protocols and encryption and to protect the integrity of the data when stored on the various computing devices within the software deployment system. For example, a file-based integration scheme or a service-based integration scheme can be utilized for transmitting data between the various computing devices. Data can be transmitted using various network communication protocols. Secure data transmission protocols and/or encryption can be used in file transfers to protect the integrity of the data, for example, File Transfer Protocol (FTP), Secure File Transfer Protocol (SFTP), and/or Pretty Good Privacy (PGP) encryption. In many implementations, one or more web services can be implemented within the various computing devices. Web services can be accessed by authorized external devices and users to support input, extraction, and manipulation of data between the various computing devices in the operating environment 100. Web services built to support a personalized display system can be cross-domain and/or cross-platform and can be built for enterprise use. Such web services can be developed in accordance with various web service standards, such as the Web Service Interoperability (WS-I) guidelines. Data can be transmitted using the Secure Sockets Layer (SSL) or Transport Layer Security (TLS) protocol to provide secure connections between the computing devices. Web services can be implemented using the WS-Security standard, which provides for secure SOAP messages using XML encryption. In still other examples, a security and integration layer can include specialized hardware for providing secure web services. For example, secure network appliances can include built-in features such as hardware-accelerated SSL and HTTPS, WS-Security, and/or firewalls. Such specialized hardware can be installed and configured in the operating environment 100 in front of one or more computing devices describe herein such that any external devices can communicate directly with the specialized hardware.

It will be appreciated that the network connections shown are illustrative and other means of establishing a communications link between the computers can be used. The existence of any of various network protocols such as TCP/IP, Ethernet, FTP, HTTP and the like, and of various wireless communication technologies such as GSM, CDMA, WiFi, and WiMAX, is presumed, and the various computing devices described herein can be configured to communicate using any of these network protocols or technologies.

FIG. 2 illustrates an example computing device 200, in accordance with certain aspects of the present disclosure. The computing device 200 may correspond to the rescue system 120, as described with respect to FIG. 1. The computing device 200 can include a processor 203 for controlling the overall operation of the computing device 200 and its associated components, including RAM 205, ROM 207, input/output device 209, communication interface 211, and/or memory 215. A data bus can interconnect processor(s) 203, RAM 205, ROM 207, memory 215, I/O device 209, and/or communication interface 211.

Input/output (I/O) device 209 can include a microphone, keypad, touch screen, and/or stylus through which a user of the computing device 200 can provide input and can also include one or more of a speaker for providing audio output and a video display device for providing textual, audiovisual, and/or graphical output. In some aspects, the video display device may include a heads-up display or any display that may be built-into a vehicle. The I/O device 209 may be part of the vehicle and used to provide input to computing device 200. Software can be stored within memory 215 to provide instructions to processor 203, allowing computing device 200 to perform various actions. For example, memory 215 can store software used by the computing device 200, such as an operating system 217, application programs 299, and/or an associated internal database 221. The various hardware memory units in memory 215 can include volatile and nonvolatile, removable, and non-removable media implemented in any method or technology for storage of information such as computer-readable instructions, data structures, program modules or other data. Memory 215 can include one or more physical persistent memory devices and/or one or more non-persistent memory devices. Memory 215 can include, but is not limited to, random access memory (RAM) 205, read only memory (ROM) 207, electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 203.

Communication interface 211 can include one or more transceivers, digital signal processors, and/or additional circuitry and software for communicating via any network, wired or wireless, using any protocol as described herein. Processor 203 can include a single central processing unit (CPU), which can be a single-core or multi-core processor (e.g., dual-core, quad-core, etc.), or can include multiple CPUs. Processor(s) 203 and associated components can allow the computing device 200 to execute a series of computer-readable instructions to perform some or all of the processes described herein. Although not shown in FIG. 2, various elements within memory 215 or other components in computing device 200, can include one or more caches, for example, CPU caches used by the processor 203, page caches used by the operating system 217, disk caches of a hard drive, and/or database caches used to cache content from database 221. For implementations including a CPU cache, the CPU cache can be used by one or more processors 203 to reduce memory latency and access time. A processor 203 can retrieve data from or write data to the CPU cache rather than reading/writing to memory 215, which can improve the speed of these operations. In some examples, a database cache can be created in which certain data from a database 221 is cached in a separate smaller database in a memory separate from the database, such as in RAM 205 or on a separate computing device. For instance, in a multi-tiered application, a database cache on an application server can reduce data retrieval and data manipulation time by not needing to communicate over a network with a back-end database server. These types of caches and others can be included in various implementations and can provide potential advantages in certain implementations of software deployment systems, such as faster response times and less dependence on network conditions when transmitting and receiving data.

In some aspects, the computing device 200 may include a state engine 290. The state engine 290 may include a lock releaser component 219, state persistence component 220, lifecycle data engine 222, timeout persistence component 224, state read component 226, lock acquirer component 228, verification component 230, and action identification component 233. The lock acquirer component 228 may engage a lock of the state engine. For example, the lock acquirer component 228 may indicate to a computing device (e.g., server) that the state engine is undergoing an adjustment and should not be accessed or modified until the lock is released. Once any particular transition, event, or associated actions are completed, the lock may be released by the lock releaser component 219.

The state read component 226 (also referred to as a label inversion resolver) reads a current state of the state engine (e.g., from database 221), allowing for the state of the state engine to be saved, and the state persistence component 220 writes back a state of the state engine (e.g., to the database 221). For example, the state read component 226 may read a current state of the state engine, allowing for the current state or a target state to be verified, as described herein. Upon transition to a target state, the state persistence component 220 may write the state of the state engine back to the database. The lifecycle data engine 222 facilitates storage of data (e.g., housekeeping data) in the system (e.g., memory 215) for a particular lifecycle (e.g., a particular rescue operation such as a towing operation). The timeout persistence component 224 manages and adjusts a priority queue of actions to be performed, which may be specific to an event or state, as described in more detail herein. Although various components of computing device 200 are described separately, functionality of the various components can be combined and/or performed by a single component and/or multiple computing devices in communication. For example, lock releaser component 219, state persistence component 220, lifecycle data engine 222, timeout persistence component 224, state read component 226, lock acquirer component 228, verification component 230, and action identification component 233 may be implemented as part of processor 203.

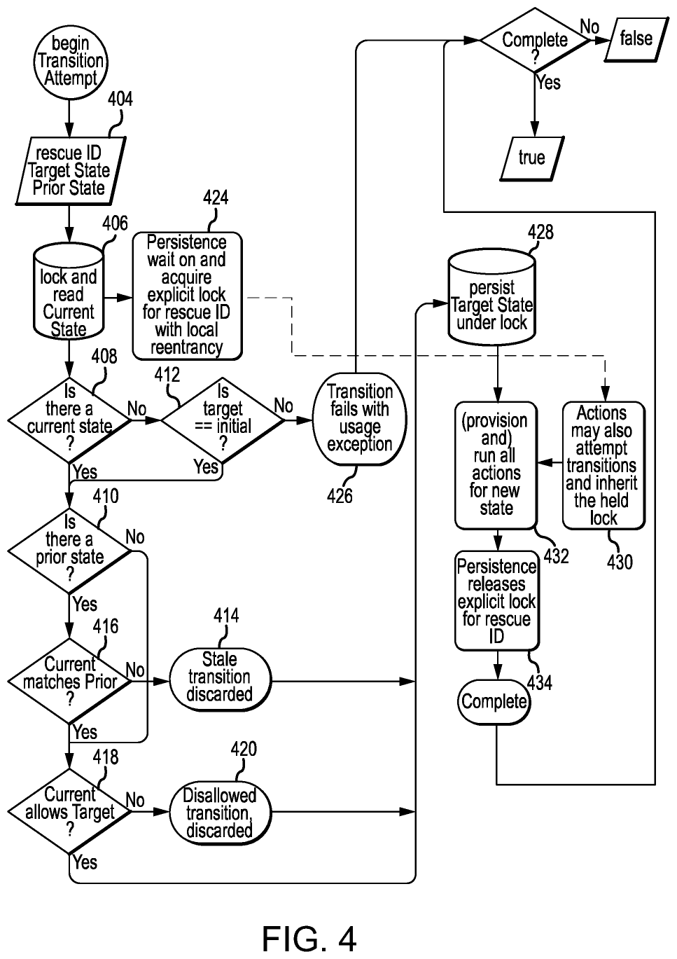

As shown, the computing device 200 may also include a verification component 230. The verification component 230 may verify that a particular transition from a current state to a target state of the state engine is valid, as described in more detail herein with respect to FIG. 4. The computing device 200 may include an action identification component 233, which identifies whether one or more actions are to be taken and what such actions should be (e.g., a type of message to a user) based on rescue factors. Such action may be performed via an action component 232, which may be a system for sending messages to users. As shown, the computing device 200 may include a transition component 234, which may manage transitions from one state to another for the state engine.

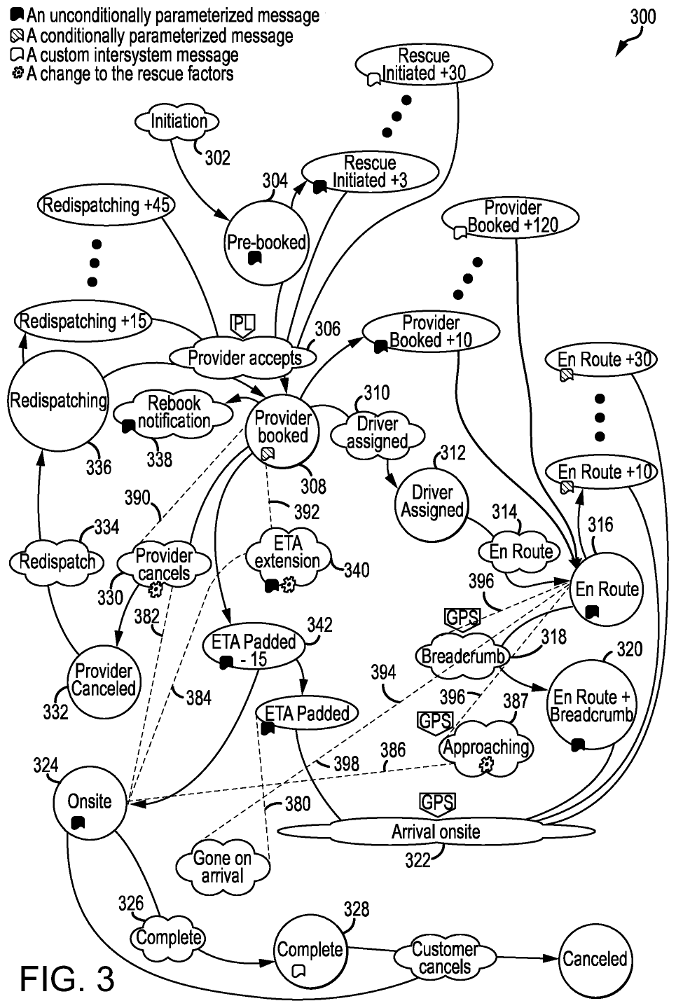

FIG. 3 is a flow diagram of a state machine for implementing a vehicle rescue operation, in accordance with certain aspects of the present disclosure. As shown, the rescue operation begins at an initiation event 302 and continues to a prebooked state 304. The initiation event 302 may involve receiving an indication from a source to initiate a new rescue lifecycle.

At the prebooked state 304, an unconditionally parameterized message may be sent to the user device, indicating that the rescue operation is prebooked. Providers may be requested to perform the rescue operation. Once a particular provider accepts at event 306, the current state may transition from the provider booked state 308. As shown, various delay events may occur, such as rescue initiated+3 indicating that there has been a 3-minute delay since prebooking with no provider being booked. Similarly, there may be other delay events such as rescue initiated+7 (e.g., 7 minutes of delay) and rescue initiated+30 (e.g., 30 minutes of delay). As shown, each event may result in a message to the user. In a similar manner, there may be various delay events for the provider booked state, including provider booked+10 (e.g., indicating a 10-minute delay), provider booked+20 (e.g., indicating a 20-minute delay), and so on.

Once a driver is assigned at event 310, the state transitions to a driver assigned state 312. Once the driver is en route for the rescue operation at event 314, the current state transitions to the en route state 316. As shown, there may be various delay events from the en route state, as described herein.

In some aspects, it may be determined at 318 that breadcrumbs (e.g., GPS coordinates) are available to provide an en route state of the driver to the user device. As shown, the current state may then transition to an en route and breadcrumb state 320, where messages may be sent to the user device providing updates as to the location of the driver for the rescue operation. If at event 387, the driver is approaching the rescue location, one or more rescue factors may be adjusted. The rescue factors may be used to determine an action, such as a specific message to be sent to the user device. The factors may be specific to a type of rescue. For example, suppose the rescue is a towing operation. In that case, the rescue factors may include a type of towing, the initial estimated time of arrival compared to a current estimated time of arrival, or the estimated time of arrival compared to a classification (e.g., importance) of the rescue.

Once the driver has arrived on site at event 322, the current state transitions to the onsite state 324. Once the rescue operation has been completed at event 326, the current state transitions to the complete state 328.

As shown, if at the provider booked state 308, the provider cancels at event 330 (e.g., resulting in the rescue factors being changed), the current state transitions to the provider canceled state 332. Once redispatching begins at event 334, the current state transitions to redispatching state 336. As shown, multiple delay events may occur from the redispatching state 336, as shown. In some aspects, at event 338, a rebook notification may occur from the provider booked state 308, as shown. In some cases, an estimated time of arrival (ETA) may be extended at event 340, which may result in the rescue factors being changed. In some cases, at event 342, an ETA may be padded (e.g., extended by 15 minutes).

Certain aspects of the present disclosure are directed towards verification of events or state transitions based on one or more constraints associated with the state engine. For example, the arrows from one state to another or from one state to any event may be constraints associated with the state engine. For example, a transition may occur from driver assigned state to the en route state 316 (e.g., via the occurrence of en route event 314), but a transition may not occur from provider booked state 308 straight to en route state 316. Moreover, lines 390, 392, 394, 396, 398 (e.g., indicating constraints of the state engine) indicate a start of validity for a particular state. Lines 380, 382, 384, 386 (e.g., indicating constraints of the state engine) indicate an end of validity for the particular state. For example, as shown by line 390 and line 382, the provider canceled event 330 is a valid event to occur from state 308 until state 324 (e.g., is valid for states 308, 312, 316, 320, 324, but not a valid event for other states).

As shown, various states or events may result in either a conditionally parameterized or unconditionally parameterized message. For example, the prebooked state 304 may result in an unconditionally parameterized message, whereas the provider booked state 308 may result in a conditionally parameterized message. Unconditionally parameterized refers to where parameters are directly passed to an event. Conditionally parameterized refers to where parameters may be withheld or an event suppressed entirely based on action-specific logic. Some events may result in a custom intersystem message. For example, the provider booked+120 event (e.g., indicating a 2-hour delay) may result in an intersystem message (e.g., to a service manager) indicating such a long delay for remedial actions to be taken.

FIG. 4 is a block diagram illustrating example operations for transitioning from one state to another state of a state diagram, in accordance with certain aspects of the present disclosure. A state transition is a change, for a given lifecycle (e.g., rescue operation such as towing), from one state label and version to another state label and a new version. A state may have an arbitrary but non-zero duration in time and may be usefully considered to have an arbitrary but distinct starting and end time. A label may be a human-readable label assigned to a state. It may be useful to use a convention of passive-voice or “condition” words or phrases to distinguish states from related events, in particular the event(s) that cause(s) a related state to be entered. In addition to a label, each state may have a unique numeric value (referred to as an ordinal) identifying its sequence in the lifecycle. This does not imply a linear flow between states, but states with higher ordinals can be considered to happen, disregarding cycles, after states with lower ordinals. For various reasons, the ordinals of the various states in a given lifecycle compose a compactly-well-ordered increasing sequence starting with 0. A version is a compactly-well-ordered monotonically increasing value. For example, the sequence number of a particular state may change relative to the beginning of the lifecycle.

An event is an occurrence for a given lifecycle that may be considered to happen at a point in time, as opposed to persisting over a duration. Events may also be labeled as it may be useful to use a convention of active-voice or “action” words or phrases to distinguish events from states. In particular, a state is reached by an event that triggers a transition. Actual transition and event actions may be performed by injected implementations, which may be provisioned and run by the state engine. The action delegation mechanism is itself based on delegated injectors and may be customizable. In addition to the action delegation framework, the state engine delegates to injected mechanisms. State persistence local-only implementations can use any java virtual machine (JVM) data structure. Bindings can be made directly to functional interface targets of existing persistence classes.

As shown, at block 404, a rescue ID, target state, and prior state associated with a transition may be obtained. The rescue ID may indicate a type of rescue that is being performed, such as a tow rescue. At block 406, the current state of the state engine may be locked and read from a database. The locking mechanism may be implemented using a plugin (e.g., a persistence mechanism). Once the state engine is locked, other instances of the state engine are unable to modify the current state. Moreover, at block 424, persistence (e.g., via state persistence component 220 and/or timeout persistence component 224) waits on and acquires an explicit lock for the rescue ID with local reentrancy. In other words, the lock may persist for multiple actions to be performed. For example, at block 430, an action may attempt transitions that inherit the held lock to perform those actions.

At block 408, the state engine may determine whether there is a current state. If not, at block 412, it may be determined whether the target state is the initial state of the state machine (e.g., the prebooked state 304). If not, then the transition fails at block 426. If there is a current state or the target state is the initial state, at block 410, the state engine determines whether there is a prior state, and if so, at block 416, the state engine determines whether the current state matches the prior state. In other words, the state engine verifies that the current state is valid given the prior state. If not, at block 414, the state transition is discarded. If so, at block 418, the state engine determines whether the current state allows for the target state. For example, referring back to FIG. 3, the driver assigned state 312 may be an allowed target state if the current state is the provider booked state 308, but not an allowed target state if the current state is the prebooked state 304. If the target state is not allowed from the current state, the state transition is discarded at block 420, as shown. If the target state is allowed, at block 428, the state engine persists the target state under lock. For example, the target state may be stored in the database and set as the new current state. At block 432, the state engine may run the actions for the new state. Actions may be implemented as a runnable. A runnable (e.g., Java runnable) is an interface used to execute code on a concurrent thread. Prior to running the action, the action may be parameterized (e.g., associated with parameters) that are appropriate for the current state. For example, a particular action (e.g., sending a specific text message to a user) may be assigned parameters based on the current state of the state engine, where the action (e.g., message to the user) is performed (e.g., generated) based on such parameters. As an example, the runnable derived for sending a text message to a user would parameterize with user ID, rescue factors, and current state. Once all actions have been performed, at block 434, the state engine may release the lock.

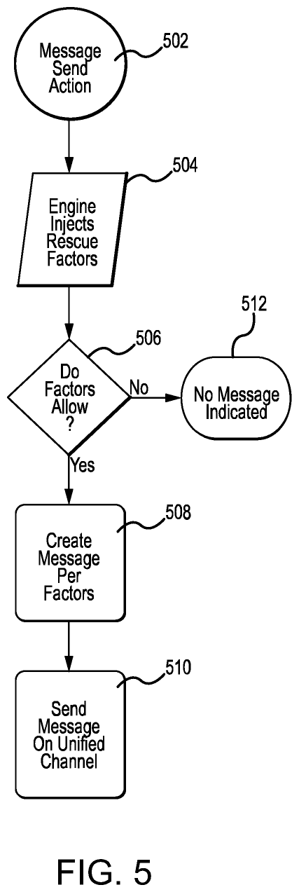

FIG. 5 is a block diagram illustrating example operations for implementing an action, in accordance with certain aspects of the present disclosure. For example, a message send action may begin at block 502. At block 504, the state engine injects rescue factors. The rescue factors include factors based on which a particular action may be determined, such as a type of message to be sent to the user device. At block 506, the state engine determines whether the factors allow the action to be performed, and if not, at block 512, the state engine determines not to send the message. If the factors allow the message to be sent, at block 508, the message is created in accordance with the factors. At block 510, the message may be sent using any suitable mechanism, such as on a unified channel.

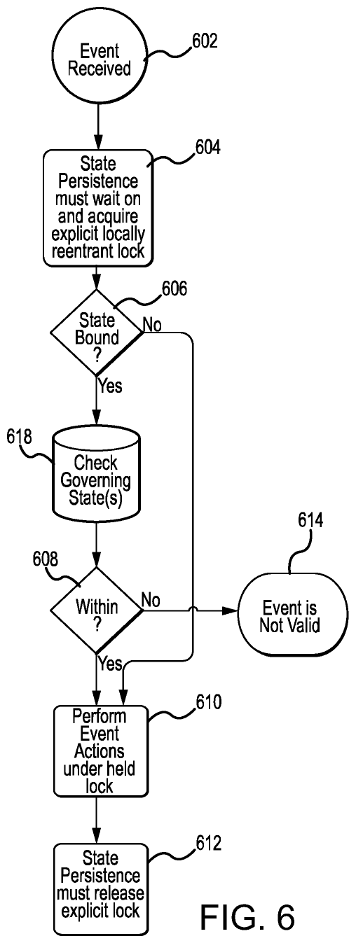

FIG. 6 is a block diagram illustrating example operations for processing an event, in accordance with certain aspects of the present disclosure. As shown, at block 602, a particular event may be received. At block 604, the state engine (e.g., persistence plugin) waits on and acquires an explicit locally reentrant lock. At block 606, the state engine determines whether the event is state bound (e.g., is an event that results in a transition to a state). If not, at block 610, the state engine performs the event actions under the held lock. For example, the actions may be performed using the operations described with respect to FIG. 5. If the event is state bound, then at block 618, the state engine checks the governing state(s) from a database, and at block 608, determines whether the event is within the state (e.g., is allowed by the governing state(s)). If not, at block 614, the state engine determines that the event is invalid, and if so, proceeds to block 610 where the actions associated with the event are performed. Once the actions are performed, at block 612, the persistence plugin releases the lock.

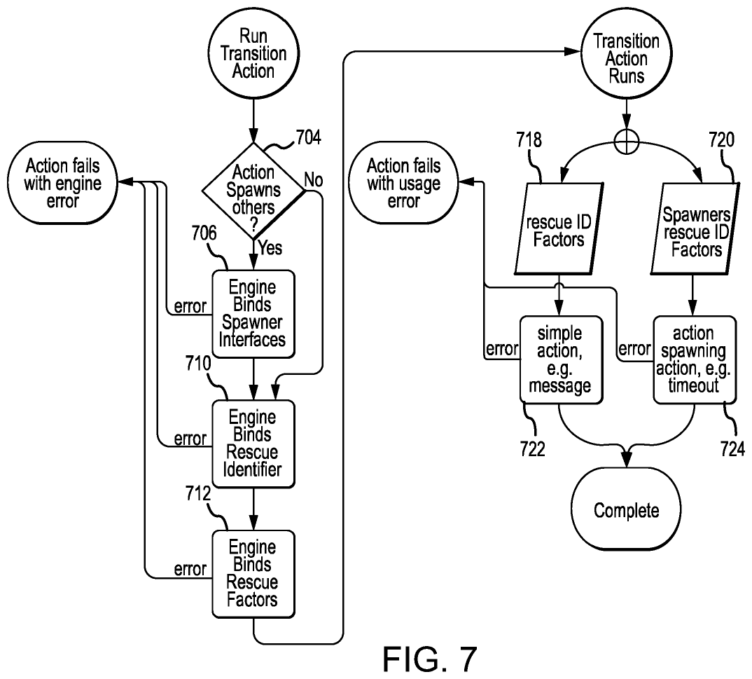

FIG. 7 is a block diagram illustrating example operations for performing one or more actions, in accordance with certain aspects of the present disclosure. As shown, at block 704, the state engine determines whether a particular action (e.g., an action associated with an event that has occurred) spawns other actions. If so, at block 706, the state engine may bind spawner interfaces to initiate the spawned actions. At block 710, the state engine binds a rescue ID to the action, and at block 712, binds rescue factors to the action, as shown.

At block 718, the rescue ID and rescue factors are retrieved, and at block 722, the action (e.g., message to the user) may be selected. For example, a lookup table may be used to select a message based on the rescue factors. For instance, based on the factor and the rescue ID (e.g., rescue type such as towing), the lookup table may be used to determine whether to send a message and what message is to be sent. Moreover, at block 720, if the action spawns another action, the spawned actions rescue ID factors are retrieved, and at block 724, the spawned action is identified based on the rescue factors and performed. As an example, the spawned action may be a timeout action. For instance, the timeout action may acknowledge a delay and provide resolution options.

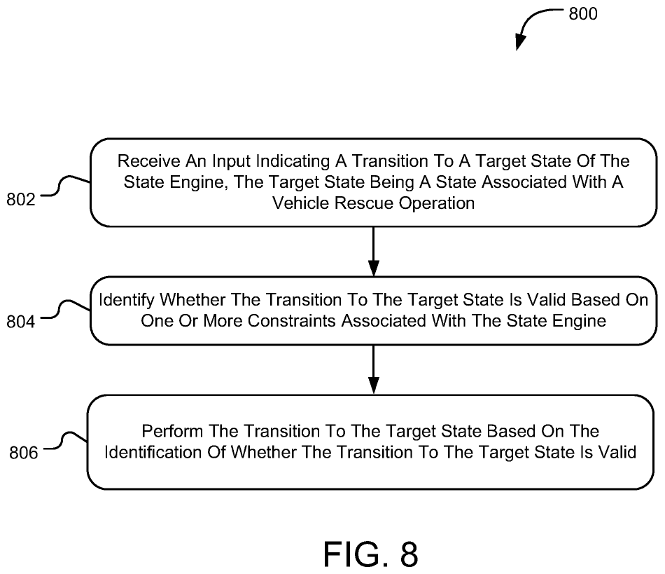

FIG. 8 is a flow diagram illustrating example operations 800 for providing rescue status updates, in accordance with certain aspects of the present disclosure. The operations 800 may be performed, for example, by a rescue system, such as the computing device 200, including a state engine (e.g., state engine 290) and in some aspects, the memory 215.

At block 802, the state engine receives (e.g., via an input interface such as the input/output device 209) an input indicating a transition to a target state of the state engine, the target state being a state for a rescue operation. The input indicating the transition may include an input indicating an occurrence of an event that triggers the transition

At block 804, the state engine identifies (e.g., via a verification component coupled to the input interface) whether the transition to the target state is valid based on one or more constraints. In some aspects, identifying whether the transition is valid may involve determining whether the state engine is associated with a current state, and determining whether the current state allows the transition to the target state based on the one or more constraints.

In some aspects, identifying whether the transition is valid may include determining whether the state engine is associated with a current state, and determining whether the target state is an initial state of the state engine. The transition may be invalid if the state engine is not associated with a current state and the target state is not the initial state.

At block 806, the state engine performs (e.g., via transition component 234) the transition to the target state based on the identification. In some aspects, the state engine may determine whether a current state of the state engine is allowed based on a prior state of the state engine. The transition may be performed based on the determination. In some aspects, the state engine locks a state of the state engine until the transition and one or more actions triggered by the transition are performed. For example, the state engine may lock a state of the state engine via a lock acquirer component (e.g., lock acquirer component 228), perform one or more actions associated with the rescue operations, and unlock the state of the state engine via a lock releaser component (e.g., lock releaser component 219) after the one or more actions are performed.

The state engine may identify one or more actions associated with the transition or an occurrence of an event, identify one or more rescue factors associated with the one or more actions, and perform the one or more actions based on the one or more rescue factors. In some aspects, the state engine determines whether the one or more rescue factors allow for the one or more actions to be performed. The one or more actions may be performed based on the determination. In some aspects, performing the one or more actions may include creating a message to be sent (e.g., to a user device) for the rescue operation based on one or more rescue factors.

In some aspects, the state engine receives an indication of an occurrence of an event, determines whether a current state of the state engine allowed for the event to occur, and performs one or more actions associated with the event in response to the determination. In some aspects, the state engine identifies one or more actions to be performed for the rescue operations, determines a rescue identifier indicating a type of rescue associated with the one or more actions, determines one or more rescue factors associated with the one or more actions, and performs the one or more actions based on the rescue identifier and the one or more rescue factors.

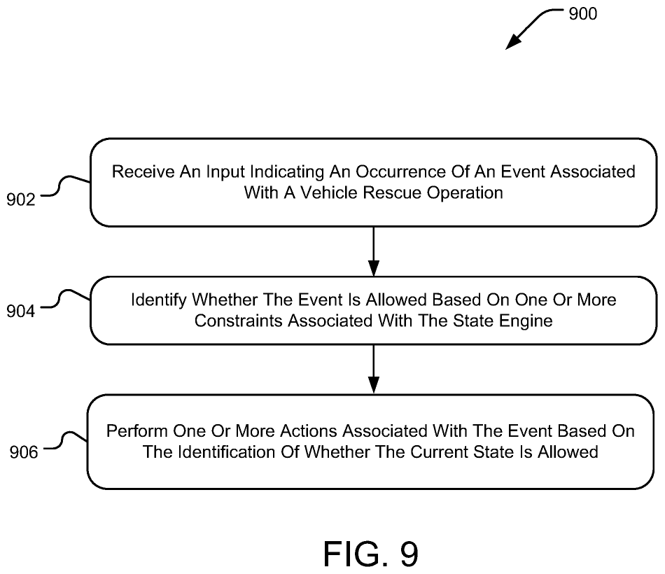

FIG. 9 is a flow diagram illustrating example operations 900 for providing rescue status updates, in accordance with certain aspects of the present disclosure. The operations 900 may be performed for example, by a rescue system, such as the computing device 200 including a state engine (e.g., state engine 290), and in some aspects, the memory 215.

At block 902, the state engine receives (e.g., via an input interface such as the input/output device 209) an input indicating an occurrence of an event associated with a vehicle rescue operation. At block 904, the state engine identifies (e.g., via verification component 230 coupled to the interface) whether the event is allowed based on one or more constraints associated with the state engine. For example, to identify whether the event is allowed, the verification component may identify whether a current state of the state engine allowed for the event to occur. At block 906, the state engine performs (e.g., action component 232 coupled to the verification component) one or more actions associated with the event based on the identification of whether the current state is allowed.

In some aspects, the occurrence of the event triggers a transition to a target state of the state engine. The verification component may identify whether the transition to the target state is valid based on one or more constraints associated with the state engine. The state engine may perform (e.g., via transition component 234 coupled to the verification component) the transition to the target state based on the identification of whether the transition to the target state is valid.

In some aspects, the verification component identifies whether the transition is valid by determining whether the state engine is associated with a current state, and determining whether the current state allows the transition to the target state based on the one or more constraints.

In some aspects, the verification component identifies whether the transition is valid by determining whether the state engine is associated with a current state, and determining whether the target state is an initial state of the state engine, wherein the transition is invalid if the state engine is not associated with a current state and the target state is not the initial state.

In some aspects, the state engine identifies one or more rescue factors associated with the one or more actions. The state engine may identify (e.g., via action identification component 233) the one or more actions associated with a current state of the state engine based on the one or more rescue factors. In some aspects, the rescue system includes a communication interface (e.g., communication interface 211) coupled to the action component. The action component may perform the one or more actions by sending, via the communication interface, a message providing an update regarding the rescue operation to a user device.

Implementations of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an implementation in the present disclosure can be references to the same implementation or any implementation; and such references mean at least one of the implementations.

Reference to “one implementation” or “an implementation” means that a particular feature, structure, or characteristic described in connection with the implementation is included in at least one implementation of the disclosure. The appearances of the phrase “in one implementation” in various places in the specification are not necessarily all referring to the same implementation, nor are separate or alternative implementations mutually exclusive of other implementations. Moreover, various features are described which may be exhibited by some implementations and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various implementations given in this specification.

Without intent to limit the scope of the disclosure, examples of instruments, apparatus, methods and their related results according to the implementations of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

We claim:

1. A system for vehicle rescue, comprising:
an interface of a state engine configured to receive an input indicating a transition to a target state of the state engine, the target state being a state associated with a vehicle rescue operation;
a verification component coupled to the interface, the verification component configured to identify whether the transition to the target state is valid based on one or more constraints associated with the state engine; and
a transition component coupled to the verification component, the transition component configured to perform the transition to the target state based on the identification of whether the transition to the target state is valid.

2. The system of claim 1, wherein to identify whether the transition is valid, the verification component is configured to:
determine whether the state engine is associated with a current state; and
determine whether the current state allows the transition to the target state based on the one or more constraints.

3. The system of claim 1, wherein to identify whether the transition is valid, the verification component is configured to:
determine whether the state engine is associated with a current state; and
determine whether the target state is an initial state of the state engine, wherein the transition is invalid if the state engine is not associated with the current state and the target state is not the initial state.

4. The system of claim 1, wherein the verification component is further configured to determine whether a current state of the state engine is allowed based on a prior state of the state engine, the transition component being configured to perform the transition based on the determination by the verification component.

5. The system of claim 1, further comprising a lock acquirer component configured to lock a state of the state engine until the transition and one or more actions triggered by the transition are performed.

6. The system of claim 1, wherein the input indicating the transition comprises an input indicating an occurrence of an event that triggers the transition.

7. The system of claim 1, wherein:
the state engine is configured to identify one or more rescue factors associated with the state engine; and
the system further comprises:
an action identification component configured to identify one or more actions associated with a current state of the state engine based on the one or more rescue factors; and
an action component configured to perform the one or more actions.

8. The system of claim 7, further comprising a communication interface coupled to the action component, wherein the action component is configured to perform the one or more actions by sending, via the communication interface, a message providing an update regarding the rescue operation to a device.

9. The system of claim 7, wherein the state engine is configured to determine whether the one or more rescue factors allow for the one or more actions to be performed, wherein the one or more actions are performed based on the determination.

10. The system of claim 7, wherein the action component is configured to perform the one or more actions by creating a message to be sent for the rescue operation based on the one or more rescue factors.

11. The system of claim 1, further comprising:
a communication interface configured to receive an indication of an occurrence of an event, wherein the verification component is configured to determine whether a current state of the state engine allows for the event to occur; and
an action component configured to perform one or more actions associated with the event in response to the determination.

12. The system of claim 1, wherein:
the state engine is configured to determine a rescue identifier indicating a type of the rescue operations;
the state engine is configured to identify one or more rescue factors; and
the system further comprises:
an action identification component configured to identify one or more actions to be performed for the rescue operations based on the rescue identifier and the one or more rescue factors; and
an action component configured to perform the one or more actions.

13. The system of claim 1, further comprising:
a lock acquirer component configured to lock a state of the state engine;
an action component configured to perform one or more actions associated with the rescue operations; and
a lock releaser component configured to unlock the state of the state engine after the one or more actions are performed.

14. An system for vehicle rescue, comprising:
an interface of a state engine configured to receive an input indicating an occurrence of an event associated with a vehicle rescue operation;
a verification component coupled to the interface, the verification component configured to identify whether the event is allowed based on one or more constraints associated with the state engine; and
an action component coupled to the verification component, the action component configured to perform one or more actions associated with the event based on the identification of whether the event is allowed.

15. The system of claim 14, wherein, to identify whether the event is allowed, the verification component is configured to identify whether a current state of the state engine allowed for the event to occur.

16. The system of claim 14, wherein:
the occurrence of the event triggers a transition to a target state of the state engine;
the verification component is configured to identify whether the transition to the target state is valid based on the one or more constraints associated with the state engine; and
the system further comprises a transition component coupled to the verification component, the transition component being configured to perform the transition to the target state based on the identification of whether the transition to the target state is valid.

17. The system of claim 16, wherein the verification component is configured to identify whether the transition is valid by:
determining whether the state engine is associated with a current state; and
determining whether the current state allows the transition to the target state based on the one or more constraints.

18. The system of claim 16, wherein the verification component is configured to identify whether the transition is valid by:
determining whether the state engine is associated with a current state; and
determining whether the target state is an initial state of the state engine, wherein the transition is invalid if the state engine is not associated with the current state and the target state is not the initial state.

19. The system of claim 14, wherein:
the state engine is configured to identify one or more rescue factors associated with the one or more actions; and
the system further comprising an action identification component configured to identify the one or more actions associated with a current state of the state engine based on the one or more rescue factors.

20. One or more non-transitory computer-readable media having instructions stored thereon, which when executed by one or more processors, cause the one or more processors to:
receive, via an interface of a state engine, an input indicating a transition to a target state of the state engine, the target state being a state associated with a vehicle rescue operation;
identify, via a verification component coupled to the interface, whether the transition to the target state is valid based on one or more constraints associated with the state engine; and
perform, via a transition component coupled to the verification component, the transition to the target state based on the identification of whether the transition to the target state is valid.
